(19) United States
(12) Patent Application Publication
(10) Pub. No.: US 2025/0309598 A1
(43) Pub. Date: Oct. 2, 2025

(54) CONDUCTIVE TERMINAL STRUCTURE AND SOCKET

(71) Applicant: Bellwether Electronic (Kunshan) Co., Ltd., Jiangsu (CN)

(72) Inventors: Xiang-Biao TANG, Jiangsu (CN); Li-Yong BAI, Jiangsu (CN); Jinjun XU, Jiangsu (CN)

(21) Appl. No.: 18/743,138

(22) Filed: Jun. 14, 2024

(30) Foreign Application Priority Data
Mar. 28, 2024 (CN) 202410366539.2

(51) Int. Cl. H01R 31/06; H01R 13/15

(52) U.S. Cl. CPC H01R 31/06; H01R 13/15

(57) ABSTRACT

A conductive terminal structure includes two support portions, plural connecting ribs, and at least one spring plate. The two support portions are spaced from each other at a distance and extend along a first direction. The connecting ribs are disposed with intervals and extend along a second direction perpendicular to the first direction. Two ends of each of the connecting ribs respectively connect the two support portions, and the connecting ribs have a concave shape. The spring plate extends along the second direction and has a fixed end and a contact end distal to the fixed end. The fixed end connects one of the two support portions, and the contact end is suspended without support. When the conductive terminal structure is rolled to form a space, the contact end of the spring plate and the connecting ribs protrude toward the space.

### CROSS-REFERENCE TO RELATED APPLICATION

This application claims priority to China Application Serial Number 202410366539.2, filed Mar. 28, 2024, which is herein incorporated by reference.

### BACKGROUND

### Field of Invention

The present disclosure relates to a conductive terminal structure and a socket having the conductive terminal structure.

### Description of Related Art

In order to realize electrical connections between different electronic devices, various types of electrical connectors already exist. Electrical connectors may include wire end connectors and board end connectors based on their location. The wire end connector is located on one end of a cable, while the board end connector is disposed on a printed circuit board. With the continuous technological advancement and innovation of various electronic products, the performance of new electronic products has been greatly improved, and the types of electrical signals have become more diverse and require more bandwidth and electric power.

Due to the development of technology, electronic devices require greater and greater currents, so power connectors require better power terminals to withstand greater currents. Generally speaking, a conductive terminal used in a printed circuit board socket is made of copper to provide better conductivity. In order to achieve good current transmission, a large number of strip-shaped connecting ribs can be designed on the conductive terminal as electrical contacts and used to clamp the pin of a male terminal, thereby forming better electrical contact. However, if the structure of the conductive terminal is not specially designed, greater force may be required when the pin being inserted into, which results in inconvenience and easily damaged. As a result, it is difficult to strike a balance between good electrical contact and appropriate insertion force.

### SUMMARY

According to some embodiments of the present disclosure, a conductive terminal structure includes two support portions, a plurality of connecting ribs, and at least one spring plate. The two support portions are spaced from each other at a distance and extend along a first direction. The connecting ribs are disposed with intervals and extend along a second direction perpendicular to the first direction, wherein two ends of each of the connecting ribs respectively connect the two support portions, and the connecting ribs have a concave shape. The spring plate extends along the second direction and has a fixed end and a contact end distal to the fixed end, wherein the fixed end connects one of the two support portions, the contact end is suspended without support. When the conductive terminal structure is rolled to form a space, the contact end of the spring plate and the connecting ribs protrude toward the space, and are configured to electrically contact a pin inserted into the space.

In some embodiments, the conductive terminal structure includes a plurality of the spring plates, wherein the spring plates are arranged in an upper row and a lower row, the spring plates in the upper row extend outward from an upper one of the two support portions, and the spring plates in the lower row extend outward from a lower one of the two support portions.

In some embodiments, one of the spring plates in the upper row is located between two of the spring plates in the lower row, and another one of the spring plates in the upper row is located between one of the spring plates in the lower row and one of the connecting ribs; and one of the spring plates in the lower row is located between two of the spring plates in the upper row, and another one of the spring plates in the lower row is located between one of the spring plates in the upper row and one of the connecting ribs.

In some embodiments, the spring plates in the upper row are alternately disposed with the spring plates in the lower row such that the spring plates are in a comb teeth arrangement.

In some embodiments, a connecting line through centers of the connecting ribs is located between a connecting line through the contact ends of the spring plates in the upper row and a connecting line through the contact ends of the spring plates in the lower row.

In some embodiments, the connecting line through the contact ends of the spring plates in the upper row, the connecting line through the centers of the connecting ribs, and the connecting line through the contact ends of the spring plates in the lower row are three parallel lines.

In some embodiments, the conductive terminal structure includes at least three connecting ribs, wherein one of the connecting ribs is connected between the far left ends of the support portions, another one of the connecting ribs is connected between the far right ends of the support portions, and the others of the connecting ribs are arranged there between.

In some embodiments, any adjacent two of the connecting ribs has at least one spring plate there between.

In some embodiments, a width of the spring plate is gradually decreased from the fixed end to the contact end.

In some embodiments, a flexible height of the connecting ribs is less than a flexible height of the contact end of the spring plate, such that the contact end is deeper into the space than the connecting ribs.

In some embodiments, the two support portions, the connecting ribs, and the spring plate are integrally formed as a metal plate.

According to some embodiments of the present disclosure, a socket includes a connecting body and a conductive terminal structure. The connecting body has an accommodating space configured to receive an insertion of a pin. The conductive terminal structure is rolled and disposed in the accommodating space of the connecting body. When the pin is inserted into the accommodating space, the conductive terminal structure is located between the connecting body and the pin such that the connecting body is electrically connected to the pin. The conductive terminal structure includes two support portions, a plurality of connecting ribs, and at least one spring plate. The two support portions are spaced from each other at a distance and extend along a first direction. The connecting ribs are disposed with intervals and extend along a second direction perpendicular to the first direction, wherein two ends of each of the connecting ribs respectively connect the two support portions, and the connecting ribs have a concave shape. The spring plate extend along the second direction and has a fixed end and a contact end distal to the fixed end, wherein the fixed end connects one of the two support portions, the contact end is suspended without support, and the contact end of the spring plate and the connecting ribs protrude toward the accommodating space to electrically contact the pin.

In some embodiments, a width of the spring plate is gradually decreased from the fixed end to the contact end.

In some embodiments, the socket further includes a plate connecting portion, wherein the accommodating space is a hollow cylinder and the plate connecting portion extends along a tangential direction of the accommodating space from an extending line of the connecting body, and the extending line is parallel to a central axis of the accommodating space.

In some embodiments, the socket includes at least three connecting ribs, wherein one of the connecting ribs is connected between the far left ends of the support portions, another one of the connecting ribs is connected between the far right ends of the support portions, and the others of the connecting ribs are arranged there between.

In some embodiments, the at least one spring plate is between adjacent two of the connecting ribs.

In the aforementioned embodiments of the present disclosure, since the conductive terminal structure in the socket has the connecting rib and the spring plate, in which two ends of the connecting rib respectively connect the two support portions, the fixed end connects the support portion, and the contact end is suspended without support, when the pin is inserted into the rolled conductive terminal structure, the pin abuts against the contact end of the spring plate and then abuts against the concave-shaped connecting rib. As a result, the insertion force required for the pin can be reduced, and the electrical contact between the pin and the spring plate can be ensured. Moreover, the connecting rib not only can electrically contact the pin, but also can protect the spring plate from being over-squeezed by the pin to cause permanent deformation. In addition, when the connecting rib is squeezed by the pin, the connecting rib can close the conductive terminal structure to the connecting body to ensure good electrical contact. In other words, the connecting rib can improve the reliability and service life of the spring plate, and can reduce the contact resistance between the conductive terminal structure and the connecting body, thereby facilitating current transmission.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a perspective view of a socket and a pin according to one embodiment of the present disclosure.

FIG. 2 is an exploded view of the socket of FIG. 1.

FIG. 3 is an enlarged view of a conductive terminal structure of FIG. 2.

FIG. 4 is a top view of the conductive terminal structure of FIG. 3 after being spread.

FIG. 5 is a top view of the conductive terminal structure of FIG. 4 after being rolled.

FIG. 6 is a perspective view of the pin being inserted into the socket of FIG. 1, in which a connecting body is omitted.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

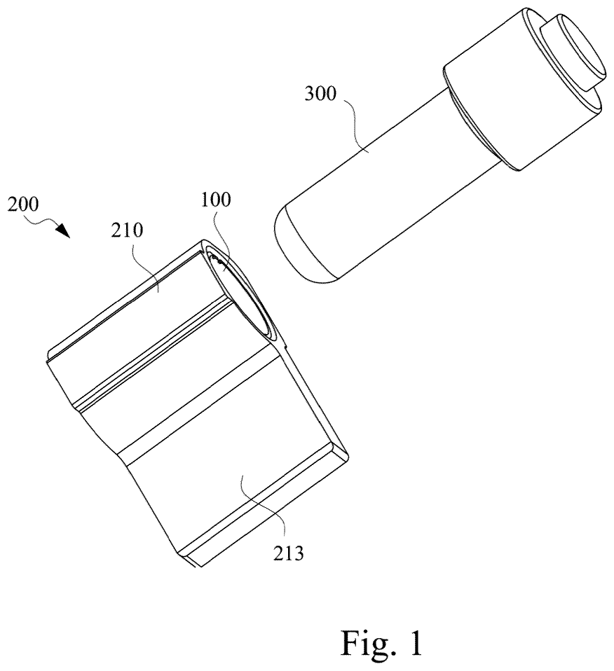

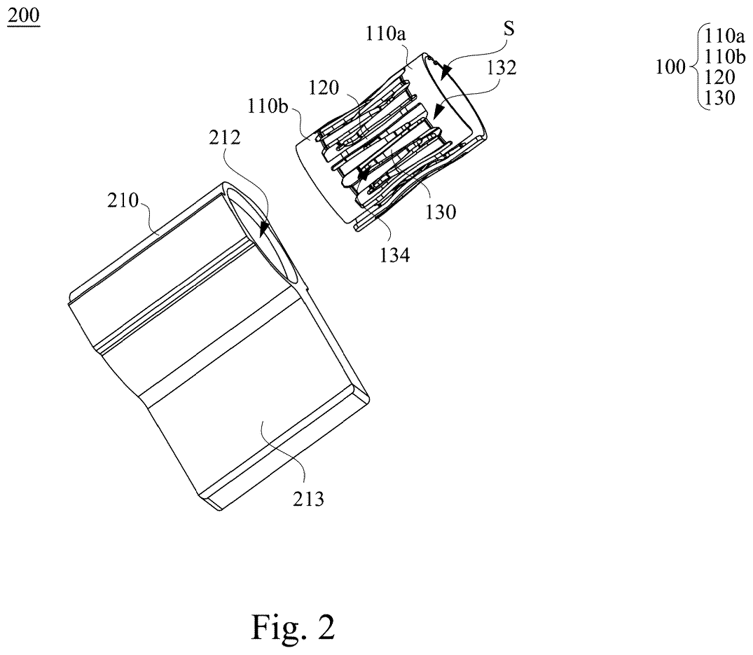

FIG. 1 is a perspective view of a socket 200 and a pin 300 according to one embodiment of the present disclosure. FIG. 2 is an exploded view of the socket 200 of FIG. 1. As shown in FIG. 1 and FIG. 2, the socket 200 can allow the pin 300 to be inserted to realize electrical contact to transmit current. In some embodiments, the socket 200 may be a board end connector or a wire end connector. In one embodiment, the socket 200 may be connected with a cable. The socket 200 and the pin 300 may be electrically connected to other electronic devices. The socket 200 includes a connecting body 210 and a conductive terminal structure 100. The connecting body 210 has an accommodating space 212 capable of containing the conductive terminal structure 100 and receiving an insertion of the pin 300. In one embodiment, the accommodating space 212 is a hollow cylinder. The socket 200 may further have a plate connecting portion 213, configured to connect to a cable, extending along a tangential direction of the accommodating space 212 from an extending line of the connecting body 210, and the extending line is parallel to a central axis of the accommodating space 212. The connecting body 210 may be a metal sleeve. The conductive terminal structure 100 is rolled and disposed in the accommodating space 212 of the connecting body 210, and a space S is formed by rolling the conductive terminal structure 100. When the pin 300 is inserted into the accommodating space 212 of the connecting body 210, the pin 300 also simultaneously is inserted into the space S surrounded by the conductive terminal structure 100, such that the conductive terminal structure 100 is located between the connecting body 210 and the pin 300. As a result, the connecting body 210 is electrically connected to the pin 300 by the conductive terminal structure 100. In other words, the conductive terminal structure 100 serves as an increased contact area between the connecting body 210 and the pin 300.

In some embodiments, the bottom portion of the connecting body 210 has a stop portion, thereby preventing the conductive terminal structure 100 from being pushed out of the connecting body 210 when the pin 300 is inserted into the connecting body 210. The connecting body 210 may be deposited in a housing that extends to a position above the top portion of the conductive terminal structure 100, thereby preventing the conductive terminal structure 100 from being pulled out of the connecting body 210 when the pin 300 is pulled out of the connecting body 210. In addition, the connecting body 210 is a metal conductor. The material of the conductive terminal structure 100 and the material of the pin 300 may be copper, but the present disclosure is not limited in this regard.

In the following description, the design of the conductive terminal structure 100 may be explained in detail.

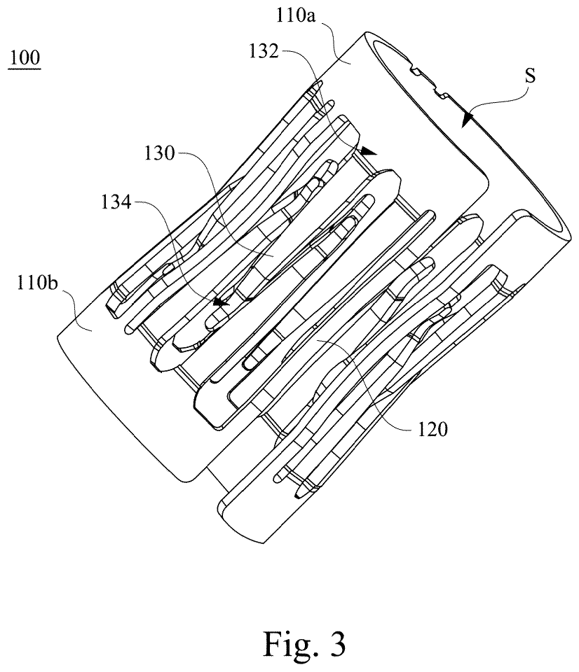

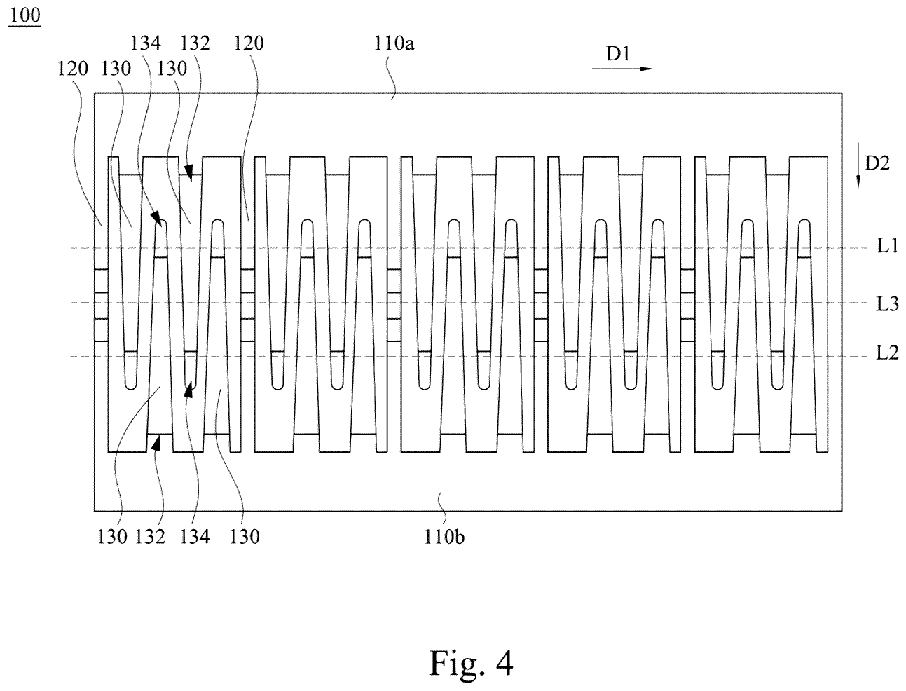

FIG. 3 is an enlarged view of the conductive terminal structure 100 of FIG. 2. FIG. 4 is a top view of the conductive terminal structure 100 of FIG. 3 after being spread. As shown in FIG. 3 and FIG. 4, the conductive terminal structure 100 includes two support portions 110a and 110b, a plurality of connecting ribs 120, and at least one spring plate 130. The two support portions 110a and 110b are spaced from each other at a distance and extend along a first direction D1. The connecting ribs 120 are disposed with intervals and extend along a second direction D2 perpendicular to the first direction D1. Two ends of the connecting rib 120 respectively connect the two support portions 110a and 110b. In one embodiment, the conductive terminal structure 100 has at least three connecting ribs 120, in which one of the connecting ribs 120 is connected between the far left ends of the support portions 110a and 110b, one thereof is connected between the far right ends of the support portions 110a and 110b, and the others thereof are arranged between the two connecting ribs 120 mentioned above. Moreover, when the connecting rib 120 is placed on a plane, the middle section of the connecting rib 120 away from the two support portions 110a and 110b has a concave shape. In this embodiment, the center of the connecting rib 120 protrudes toward the interior of the space S formed by rolling the conductive terminal structure 100. The spring plates 130 respectively extend away from the two support portions 110a and 110b, and each has a fixed end 132 and a contact end 134 distal to the fixed end 132. The fixed end 132 of the spring plate 130 connects one of the two support portions 110a and 110b, and the contact end 134 is a free end. As a result, the connecting rib 120 can be referred to as the design of a simply supported beam, and the spring plate 130 can be referred to as the design of a cantilever.

When the conductive terminal structure 100 is rolled to form the space S, the contact end 134 of the spring plate 130 and the connecting rib 120 protrude toward the space S. Stated differently, the contact end 134 of the spring plate 130 and the connecting rib 120 both protrude toward the interior of the accommodating space 212 of the connecting body 210 of FIG. 2. Therefore, the contact end 134 of the spring plate 130 and the concave-shaped connecting rib 120 can electrically contact the pin 300 (see FIG. 1) that is inserted into the space S and the accommodating space 212.

In this embodiment, the two support portions 110a and 110b, the connecting ribs 120, and the spring plate 130 are integrally formed as a metal plate (e.g., a copper plate), and the metal plate may be formed by stamping. Hollow areas between two adjacent spring plates 130 and between the connecting rib 120 and the spring plate 130 may be formed by blanking instead of tearing, and thus when the spring plate 130 is pressed, the spring plate 130 is not engaged with a tear opening to lose its function as a traditional tear-type terminal. The thickness of the aforementioned metal plate may be in a range from 0.3 mm to 0.5 mm, and the width of the hollow area may be in a range from 0.7 mm to 1.2 mm, which may be determined based on design requirements.

As shown in FIG. 1 and FIG. 3, specifically, since the conductive terminal structure 100 in the socket 200 has the connecting rib 120 and the spring plate 130, in which two ends of the connecting rib 120 respectively connect the two support portions 110a and 110b, the fixed end 132 of the spring plate 130 connects one of the support portions 110a and 110b, and the contact end 134 is suspended without support, when the pin 300 is inserted into the rolled conductive terminal structure 100, the pin 300 abuts against the contact end 134 of the spring plate 130 and the concave-shaped connecting rib 120. As a result, the insertion force required for the pin 300 can be reduced, and the electrical contact between the pin 300 and the conductive terminal structure 100 can be ensured. Moreover, the connecting rib 120 not only can electrically contact the pin 300, but also can protect the spring plate 130 from being over-squeezed by the pin 300 to cause permanent deformation. In addition, when the connecting rib 120 is squeezed by the pin 300, the connecting rib 120 can adhere the conductive terminal structure 100 to the connecting body 210 to ensure good electrical contact. In other words, the connecting rib 120 can improve the reliability and service life of the spring plate 130, and can reduce the contact resistance between the conductive terminal structure 100 and the connecting body 210, thereby facilitating current transmission.

As shown in FIG. 4, in this embodiment, the conductive terminal structure 100 includes plural spring plates 130. The spring plates 130 are arranged in an upper row and a lower row, in which the spring plates 130 in the upper row extend downward from the upper support portion 110a, and the spring plates 130 in the lower row extend upward from the lower support portion 110b. One of the spring plates 130 in the upper row (e.g., the second spring plate 130 from the left side of the upper row) may be located between two of the spring plates 130 in the lower row, and another one of the spring plates 130 in the upper row (e.g., the first spring plate 130 from the left side of the upper row) may be located between the spring plate 130 in the lower row and the connecting rib 120. Similarly, one of the spring plates 130 in the lower row (e.g., the first spring plate 130 from the left side of the lower row) may be located between two of the spring plates 130 in the upper row, and another one of the spring plates 130 in the lower row (e.g., the second spring plate 130 from the left side of the lower row) may be located between the spring plate 130 in the upper row and the connecting rib 120. At least one the spring plate 130 is between two adjacent connecting ribs 120. In one embodiment, two of the spring plates 130 in the lower row and two of the spring plates 130 in the upper row are between two adjacent connecting ribs 120. The width of the spring plate 130 is gradually decreased from the fixed end 132 to the contact end 134, and the spring plates 130 in the upper row are alternately disposed with the spring plates 130 in the lower row such that the spring plates 130 are in a comb teeth arrangement. Such a design can effectively reduce the step distance between the spring plates 130, and thus the conductive terminal structure 100 can increase the number of the spring plates 130 under the same width, which is beneficial to current transmission.

Furthermore, a connecting line L1 through the contact ends 134 of the spring plates 130 in the lower row is close to the upper support portion 110a, and a connecting line L2 through the contact ends 134 of the spring plates 130 in the upper row is close to the lower support portion 110b. A connecting line L3 through the centers of the connecting ribs 120 is located between the connecting line L2 and the connecting line L1. The connecting line L1 through the contact ends 134 of the spring plates 130 in the lower row, the connecting line L3 through the centers of the connecting ribs 120, and the connecting line L2 through the contact ends 134 of the spring plates 130 in the upper row are three parallel lines. In the aforementioned design, when the pin 300 is inserted into the rolled conductive terminal structure 100, the pin 300 can sequentially pass through the contact ends 134 of the spring plates 130 in the lower row, the centers of the connecting ribs 120, and the contact ends 134 of the spring plates 130 in the upper row. In other words, the pin 300 passes through the connecting lines L1, L3, and L2 in order.

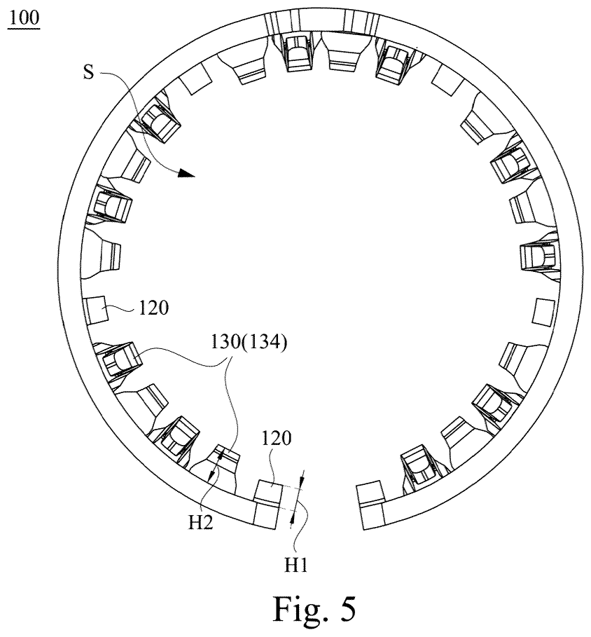

FIG. 5 is a top view of the conductive terminal structure 100 of FIG. 4 after being rolled. As shown in FIG. 5, a flexible height H1 of the connecting rib 120 is less than a flexible height H2 of the contact end 134 of the spring plate 130, such that the contact end 134 of the spring plate 130 can be deeper into the space S than the connecting ribs 120 after the conductive terminal structure 100 is rolled.

In the following description, the process of inserting the aforementioned pin 300 into the space S of the conductive terminal structure 100 will be explained.

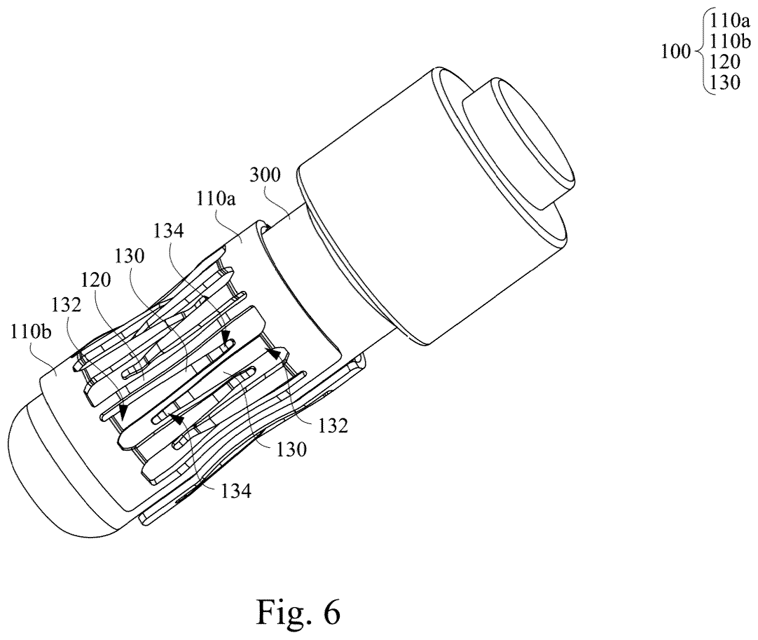

FIG. 6 is a perspective view of the pin 300 being inserted into the socket 200 of FIG. 1, in which the connecting body 210 is omitted. When the pin 300 is inserted into the space S of the conductive terminal structure 100, the pin 300 abuts against the contact ends 134 of the spring plates 130 in the lower row first (e.g., the contact ends 134 passed by the connecting line L1 of FIG. 4), and then the pin 300 can continuously be inserted to abut against the centers of the connecting ribs 120 (e.g., the positions passed by the connecting line L3 of FIG. 4) due to the flexibility of the spring plates 130. Thereafter, the pin 300 continuously is inserted to further abut against the contact ends 134 of the spring plates 130 in the upper row (e.g., the contact ends 134 passed by the connecting line L2 of FIG. 4). Since the flexible height H1 of the connecting rib 120 is less than the flexible height H2 of the contact end 134 of the spring plate 130, it can ensure a sufficient pressing amount of the spring plate 130 itself to ensure the electrical contact between the contact end 134 of the spring plate 130 and the pin 300, and the center of the connecting rib 120 can be used to limit the position of the pin 300 in a radial direction to prevent the contact end 134 of the spring plate 130 from being over-squeezed to affect service life. For example, when the contact end 134 of the spring plate 130 is squeezed by the pin 300, the contact end 134 is merely pressed down from the flexible height H2 to about the flexible height H1.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A conductive terminal structure, comprising:
two support portions spaced from each other at a distance and extending along a first direction;
a plurality of connecting ribs disposed with intervals and extending along a second direction perpendicular to the first direction, wherein two ends of each of the connecting ribs respectively connect the two support portions, and the connecting ribs have a concave shape; and
at least one spring plate extending along the second direction and having a fixed end and a contact end distal to the fixed end, wherein the fixed end connects one of the two support portions, the contact end is suspended without support, and when the conductive terminal structure is rolled to form a space, the contact end of the spring plate and the connecting ribs protrude toward the space, and are configured to electrically contact a pin inserted into the space.

2. The conductive terminal structure of claim 1, comprising a plurality of the spring plates, wherein the spring plates are arranged in an upper row and a lower row, the spring plates in the upper row extend outward from an upper one of the two support portions, and the spring plates in the lower row extend outward from a lower one of the two support portions.

3. The conductive terminal structure of claim 2, wherein the spring plates in the upper row is located between two of the spring plates in the lower row, and another one of the spring plates in the upper row is located between one of the spring plates in the lower row and one of the connecting ribs; and one of the spring plates in the lower row is located between two of the spring plates in the upper row, and another one of the spring plates in the lower row is located between one of the spring plates in the upper row and one of the connecting ribs.

4. The conductive terminal structure of claim 2, wherein the spring plates in the upper row are alternately disposed with the spring plates in the lower row such that the spring plates are in a comb teeth arrangement.

5. The conductive terminal structure of claim 2, wherein a connecting line through centers of the connecting ribs is located between a connecting line through the contact ends of the spring plates in the upper row and a connecting line through the contact ends of the spring plates in the lower row.

6. The conductive terminal structure of claim 5, wherein the connecting line through the contact ends of the spring plates in the upper row, the connecting line through the centers of the connecting ribs, and the connecting line through the contact ends of the spring plates in the lower row are three parallel lines.

7. The conductive terminal structure of claim 1, comprising at least three connecting ribs, wherein one of the connecting ribs is connected between far left ends of the support portions, another one of the connecting ribs is connected between far right ends of the support portions, and the others of the connecting ribs are arranged there between.

8. The conductive terminal structure of claim 7, wherein any adjacent two of the connecting ribs has at least one spring plate there between.

9. The conductive terminal structure of claim 1, wherein a width of the spring plate is gradually decreased from the fixed end to the contact end.

10. The conductive terminal structure of claim 1, wherein a flexible height of the connecting ribs is less than a flexible height of the contact end of the spring plate, such that the contact end is deeper into the space than the connecting ribs.

11. The conductive terminal structure of claim 1, wherein the two support portions, the connecting ribs, and the spring plate are integrally formed as a metal plate.

12. A socket, comprising:
a connecting body having an accommodating space configured to receive an insertion of by a pin; and
a conductive terminal structure rolled and disposed in the accommodating space of the connecting body, wherein when the pin is inserted into the accommodating space, the conductive terminal structure is located between the connecting body and the pin such that the connecting body is electrically connected to the pin, and the conductive terminal structure comprises:
two support portions spaced from each other at a distance and extending along a first direction;
a plurality of connecting ribs disposed with intervals and extending along a second direction perpendicular to the first direction, wherein two ends of each of the connecting ribs respectively connect the two support portions, and the connecting ribs have a concave shape; and
at least one spring plate extending along the second direction and having a fixed end and a contact end distal to the fixed end, wherein the fixed end connects one of the two support portions, the contact end is suspended without support, and the contact end of the spring plate and the connecting ribs protrude toward the accommodating space to electrically contact the pin.

13. The socket of claim 12, wherein one of a plurality of the spring plates in an upper row is located between two of the spring plates in a lower row, and another one of the spring plates in the upper row is located between one of the spring plates in the lower row and one of the connecting ribs; and one of the spring plates in the lower row is located between two of the spring plates in the upper row, and another one of the spring plates in the lower row is located between one of the spring plates in the upper row and one of the connecting ribs.

14. The socket of claim 13, wherein the spring plates in the upper row are alternately disposed with the spring plates in the lower row such that the spring plates are in a comb teeth arrangement.

15. The socket of claim 13, wherein a connecting line through centers of the connecting ribs is located between a connecting line through the contact ends of the spring plates in the upper row and a connecting line through the contact ends of the spring plates in the lower row.

16. The socket of claim 15, wherein the connecting line through the contact ends of the spring plates in the upper row, the connecting line through the centers of the connecting ribs, and the connecting line through the contact ends of the spring plates in the lower row are three parallel lines.

17. The socket of claim 12, wherein a width of the spring plate is gradually decreased from the fixed end to the contact end.

18. The socket of claim 12, further comprising a plate connecting portion, wherein the accommodating space is a hollow cylinder and the plate connecting portion extends along a tangential direction of the accommodating space from an extending line of the connecting body, and the extending line is parallel to a central axis of the accommodating space.

19. The socket of claim 12, comprising at least three connecting ribs, wherein one of the connecting ribs is connected between far left ends of the support portions, another one of the connecting ribs is connected between far right ends of the support portions, and the others of the connecting ribs are arranged there between.

20. The socket of claim 19, wherein the at least one spring plate is between adjacent two of the connecting ribs.
